(19) United States
(12) Patent Application Publication
(10) Pub. No.: US 2026/0220050 A1
(43) Pub. Date: Jul. 30, 2026

(54) System and Method for Recovering Unflushed User Data Pages from a Log Memory System

(71) Applicant: Dell Products L.P., Round Rock, TX (US)

(72) Inventors: Geng Han, Beijing (CN); Jibing Dong, Beijing (CN); Vamsi K. Vankamamidi, Hopkinton, MA (US)

(21) Appl. No.: 19/041,246

(22) Filed: Jan. 30, 2025

(51) Int. Cl. G06F 12/0891

(52) U.S. Cl. CPC G06F 12/0891

(57) ABSTRACT

A method, computer program product, and computing system for processing a plurality of user data pages on a cache memory system for writing to a storage system by generating a corresponding page descriptor for each user data page in a log memory system. At least a portion of the plurality of user data pages are flushed from the cache memory system. A special page descriptor is generated defining an array of pointers to the at least a portion of the plurality of user data pages flushed from the cache memory system. The special page descriptor is processed during a recovery operation associated with the log memory system.

### BACKGROUND

Storing and safeguarding electronic content may be beneficial in modern business and elsewhere. Accordingly, various methodologies may be employed to protect and distribute such electronic content.

For example, a log memory system may be deployed in a storage system for managing journaled user data on high-performance media with a page descriptor ring data structure. During storage system rebooting or a recovery operation, the log memory system rescans the page descriptor ring to reconstruct its tail and head. Pages located beyond these points are identified as flushed, but conventional approaches to managing these pages do not account for pages in between the head and tail, making it unclear if they pages have been flushed. Accordingly, a page that has been flushed could still be marked as dirty. Duplicate flushing of a dirty page can lead to corruption.

### SUMMARY OF DISCLOSURE

In one example implementation, a computer-implemented method executed on a computing device may include, but is not limited to, processing a plurality of user data pages on a cache memory system for writing to a storage system by generating a corresponding page descriptor for each user data page in a log memory system. At least a portion of the plurality of user data pages are flushed from the cache memory system. A special page descriptor is generated defining an array of pointers to the at least a portion of the plurality of user data pages flushed from the cache memory system. The special page descriptor is processed during a recovery operation associated with the log memory system.

One or more of the following example features may be included. Processing the special page descriptor during the recovery operation may include restoring unflushed user data pages using the special page descriptor. Restoring the unflushed user data pages may include comparing the array of pointers of the special page descriptor to the plurality of user data pages. The corresponding page descriptor for each user data page of the plurality of user data pages include a plurality of corresponding page descriptors between a head and a tail of the log memory system. A global sequence number may be generated for the special page descriptor as a value greater than a global sequence number associated with any corresponding page descriptor. The global sequence number for the special page descriptor may be processed by comparing the global sequence number to the global sequence number associated with each page descriptor. A reference count associated with remaining user data pages may be maintained for each special page descriptor. The special page descriptor may be reused in response to determining that the reference count associated with the remaining user data pages is zero.

In another example implementation, a computer program product resides on a computer readable medium that has a plurality of instructions stored on it. When executed by a processor, the instructions cause the processor to perform operations that may include, but are not limited to, processing a plurality of user data pages on a cache memory system for writing to a storage system by generating a corresponding page descriptor for each user data page in a log memory system. At least a portion of the plurality of user data pages are flushed from the cache memory system. A special page descriptor is generated defining an array of pointers to the at least a portion of the plurality of user data pages flushed from the cache memory system. The special page descriptor is processed during a recovery operation associated with the log memory system.

One or more of the following example features may be included. Processing the special page descriptor during the recovery operation may include restoring unflushed user data pages using the special page descriptor. Restoring the unflushed user data pages may include comparing the array of pointers of the special page descriptor to the plurality of user data pages. The corresponding page descriptor for each user data page of the plurality of user data pages include a plurality of corresponding page descriptors between a head and a tail of the log memory system. A global sequence number may be generated for the special page descriptor as a value greater than a global sequence number associated with any corresponding page descriptor. The global sequence number for the special page descriptor may be processed by comparing the global sequence number to the global sequence number associated with each page descriptor. A reference count associated with remaining user data pages may be maintained for each special page descriptor. The special page descriptor may be reused in response to determining that the reference count associated with the remaining user data pages is zero.

In another example implementation, a computing system includes at least one processor and at least one memory architecture coupled with the at least one processor, wherein the at least one processor configured to process a plurality of user data pages on a cache memory system for writing to a storage system by generating a corresponding page descriptor for each user data page in a log memory system. At least a portion of the plurality of user data pages are flushed from the cache memory system. A special page descriptor is generated defining an array of pointers to the at least a portion of the plurality of user data pages flushed from the cache memory system. The special page descriptor is processed during a recovery operation associated with the log memory system.

One or more of the following example features may be included. Processing the special page descriptor during the recovery operation may include restoring unflushed user data pages using the special page descriptor. Restoring the unflushed user data pages may include comparing the array of pointers of the special page descriptor to the plurality of user data pages. The corresponding page descriptor for each user data page of the plurality of user data pages include a plurality of corresponding page descriptors between a head and a tail of the log memory system. A global sequence number may be generated for the special page descriptor as a value greater than a global sequence number associated with any corresponding page descriptor. The global sequence number for the special page descriptor may be processed by comparing the global sequence number to the global sequence number associated with each page descriptor. A reference count associated with remaining user data pages may be maintained for each special page descriptor. The special page descriptor may be reused in response to determining that the reference count associated with the remaining user data pages is zero.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a cache recovery process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of cache recovery process according to one or more example implementations of the disclosure;

FIG. 4 is an example diagrammatic view of the storage system of FIG. 1 according to one or more example implementations of the disclosure; and

FIGS. 5-6 are example diagrammatic view of a special page descriptor according to one or more example implementations of the disclosure.

Like reference symbols in the various drawings indicate like elements.

### DETAILED DESCRIPTION

### System Overview

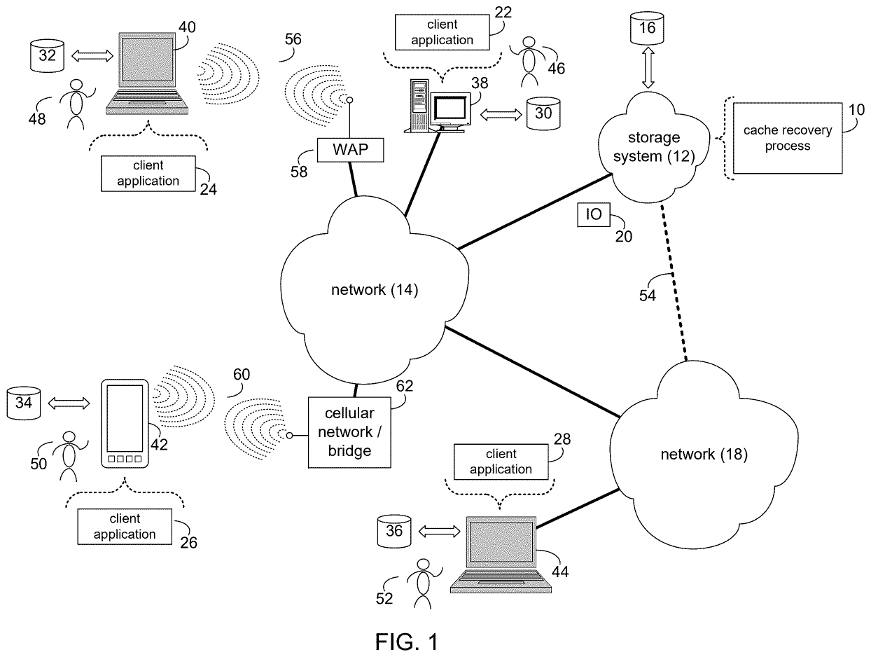

Referring to FIG. 1, there is shown cache recovery process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of cache recovery process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of cache recovery process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a cache recovery process, such as cache recovery process 10 of FIG. 1, may include but is not limited to, processing a plurality of user data pages on a cache memory system for writing to a storage system by generating a corresponding page descriptor for each user data page in a log memory system. At least a portion of the plurality of user data pages are flushed from the cache memory system. A special page descriptor is generated defining an array of pointers to the at least a portion of the plurality of user data pages flushed from the cache memory system. The special page descriptor is processed during a recovery operation associated with the log memory system.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System

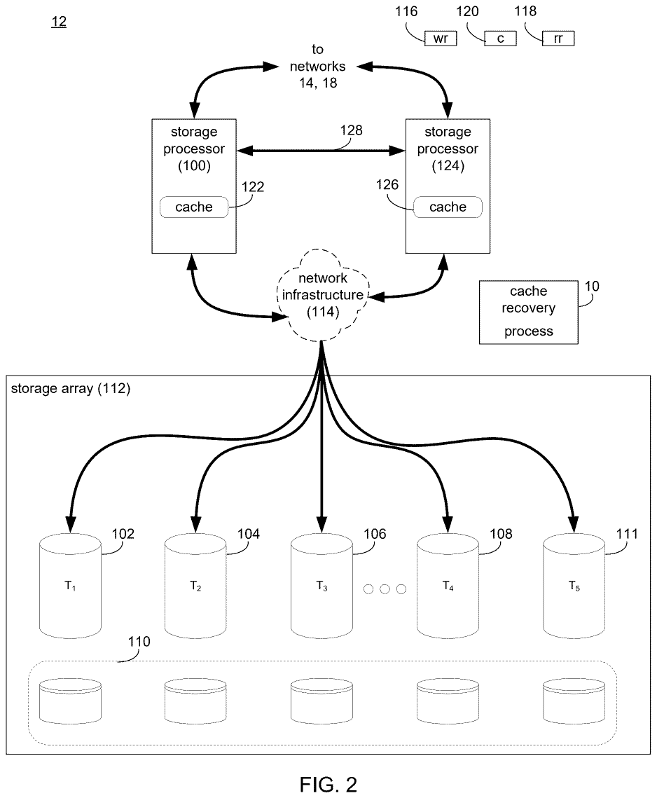

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage devices (e.g., storage devices 110) used to create the storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage devices used to create the storage targets. By mirroring data between storage devices, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g. storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 111. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 111), this is for example purposes only and is not intended to be a limitation of this disclosure. Specifically, the actual number of coded targets may be increased or decreased depending upon e.g. the level of redundancy/performance/capacity required.

Storage targets 102, 104, 106, 108 and coded target 111 may be created as volumes using one or more electro-mechanical hard disk drives and/or solid-state/flash devices (e.g., storage devices 110), wherein a combination of storage targets 102, 104, 106, 108 and coded target 111 and processing/control systems (not shown) may form data array 112.

The manner in which storage system 12 is implemented may vary depending upon e.g. the level of redundancy/performance/capacity required. For example, storage system 12 may be a RAID device in which storage processor 100 is a RAID controller card and storage targets 102, 104, 106, 108 and/or coded target 111 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 111 may be a RAID device and/or computer-based hard disk drives. Further still, one or more of storage targets 102, 104, 106, 108 and/or coded target 111 may be a SAN.

In the event that storage system 12 is configured as a SAN, the various components of storage system 12 (e.g. storage processor 100, storage targets 102, 104, 106, 108, and coded target 111) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of cache recovery process 10. The instruction sets and subroutines of cache recovery process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of cache recovery process 10 may be stored on storage devices (and/or executed by processors and memory architectures) that are external to storage system 12.

As discussed above, various IO requests (e.g. IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e. a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

As discussed above, the instruction sets and subroutines of cache recovery process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of cache recovery process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g. one or more of storage targets 102, 104, 106, 108, 111. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 111 (which would typically be slower).

In some implementations, storage system 12 may include multi-node active/active storage clusters configured to provide high availability to a user. As is known in the art, the term “high availability” may generally refer to systems or components that are durable and likely to operate continuously without failure for a long time. For example, an active/active storage cluster may be made up of at least two nodes (e.g., storage processors 100, 124), both actively running the same kind of service(s) simultaneously. One purpose of an active-active cluster may be to achieve load balancing. Load balancing may distribute workloads across all nodes in order to prevent any single node from getting overloaded. Because there are more nodes available to serve, there will also be a marked improvement in throughput and response times. Another purpose of an active-active cluster may be to provide at least one active node in the event that one of the nodes in the active-active cluster fails.

In some implementations, storage processor 124 may function like storage processor 100. For example, during operation of storage processor 124, content 118 to be written to storage system 12 may be processed by storage processor 124. Additionally/alternatively and when storage processor 124 is configured as an application server, content 118 to be written to storage system 12 may be internally generated by storage processor 124.

Storage processor 124 may include frontend cache memory system 126. Examples of frontend cache memory system 126 may include but are not limited to a volatile, solid-state, cache memory system (e.g., a dynamic RAM cache memory system) and/or a non-volatile, solid-state, cache memory system (e.g., a flash-based, cache memory system).

Storage processor 124 may initially store content 118 within frontend cache memory system 124. Depending upon the manner in which frontend cache memory system 126 is configured, storage processor 124 may immediately write content 118 to data array 112 (if frontend cache memory system 126 is configured as a write-through cache) or may subsequently write content 118 to data array 112 (if frontend cache memory system 126 is configured as a write-back cache).

In some implementations, the instruction sets and subroutines of node fencing process 10, which may be stored on storage device 16 included within storage system 12, may be executed by one or more processors (not shown) and one or more memory architectures (not shown) included within storage system 12. Accordingly, in addition to being executed on storage processor 124, some or all of the instruction sets and subroutines of node fencing 10 may be executed by one or more processors (not shown) and one or more memory architectures (not shown) included within data array 112.

Further and as discussed above, during the operation of data array 112, content (e.g., content 118) to be written to data array 112 may be received from storage processor 124 and initially stored within backend cache memory system 124 prior to being stored on e.g. one or more of storage targets 102, 104, 106, 108, 111. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 111 (which would typically be slower).

As discussed above, storage processor 100 and storage processor 124 may be configured in an active/active configuration where processing of data by one storage processor may be synchronized to the other storage processor. For example, data may be synchronized between each storage processor via a separate link or connection (e.g., connection 128).

### The Cache Recovery Process

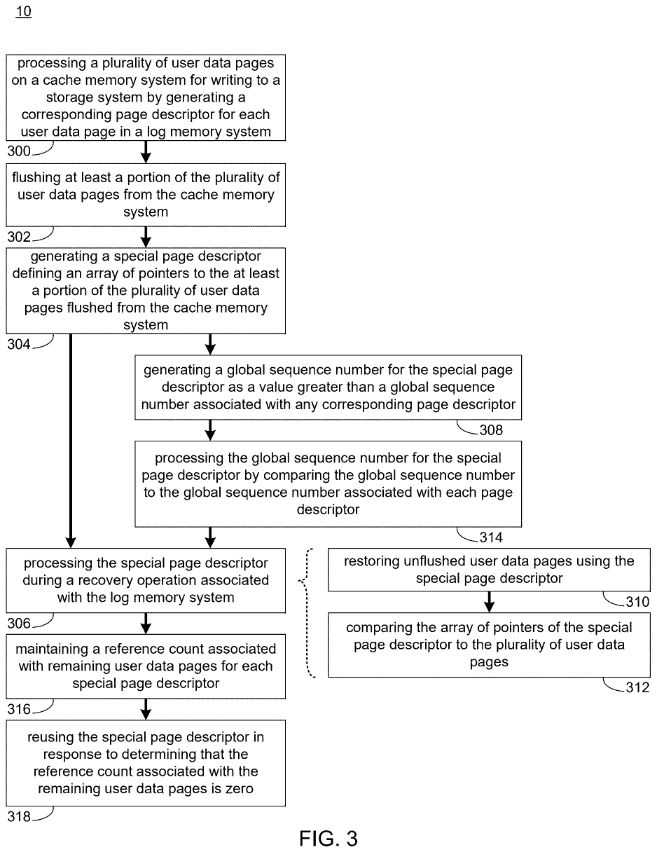

Referring also to the examples of FIGS. 3-6 and in some implementations, cache recovery process 10 may process 300 a plurality of user data pages on a cache memory system for writing to a storage system by generating a corresponding page descriptor for each user data page in a log memory system. At least a portion of the plurality of user data pages are flushed 302 from the cache memory system. A special page descriptor is generated 304 defining an array of pointers to the at least a portion of the plurality of user data pages flushed from the cache memory system. The special page descriptor is processed 306 during a recovery operation associated with the log memory system.

As will be discussed in greater detail below, implementations of the present disclosure may allow for a persistent data structure called a special page descriptor to explicitly track the flushed status of each user data page from the cache memory system. This new indicator can assist the cache memory system in recovering to the exact state where the storage system stopped. As discussed above, a log memory system may be deployed in a storage system for managing journaled user data on high-performance media with a page descriptor ring data structure. During storage system rebooting or a recovery operation, the log memory system rescans the page descriptor ring to reconstruct its tail and head. Pages located beyond these points are identified as flushed, but conventional approaches to managing these pages do not account for pages in between the head and tail, making it unclear if they pages have been flushed. Accordingly, a page that has been flushed could still be marked as dirty. Duplicate flushing of a dirty page can lead to corruption. By using the special descriptor page, the recovery operation can identify all unflushed dirty user data pages. These dirty user data pages are fed to the cache memory system in the same order they were ingested, allowing the cache memory system to recover to the state at which the storage system stopped.

In some implementations, cache recovery process 10 may generate a page buffer pool within a log memory system of a storage node. A log memory system may generally include one or more non-volatile random-access memory (NVRAM) devices configured to provide a log of the data written to storage array. For example, the contents of the log memory system may be preserved in the event of a power failure or other failure of the cache memory system. In some implementations and in response to the failure of the cache memory system, cache recovery process 10 may recover data from the log memory system. The log memory system may include two data structures, a page buffer pool and a page descriptor ring.

A page buffer pool may generally include a collection of memory within the log memory system for persisting portions of data. For example, data may be stored in the storage system in predefined portion sizes or “pages”. In one example, each page is four kilobytes (4 KB). In another example, each page is eight kilobytes (8 KB). However, it will be appreciated that the page size may be specifically defined (e.g., user-defined or automatically defined) for each storage system or application within the scope of the present disclosure.

In some implementations, generating the page buffer pool within the log memory system may include initializing the page buffer pool with a plurality of contiguous portions of a predefined block size. For example, cache recovery process 10 may initialize a pool-based structure for page buffers, which represent pages on persistent media (e.g., 4 KB or 8 KB) for low latency, write cache. The pool may be initialized with contiguous pages in a predefined block size. The predefined block size may be larger than the storage page size (e.g., 4 KB or 8 KB), as the block size which is in use by the storage system client may be, for example, 256 KB, 1 MB, or any other value. When pages are allocated, cache recovery process 10 may attempt to obtain a contiguous page buffer in the persistent media space of the log memory system for better performance, writing into the media, and for minimizing the amount of IO requests or operations sent to the persistent media.

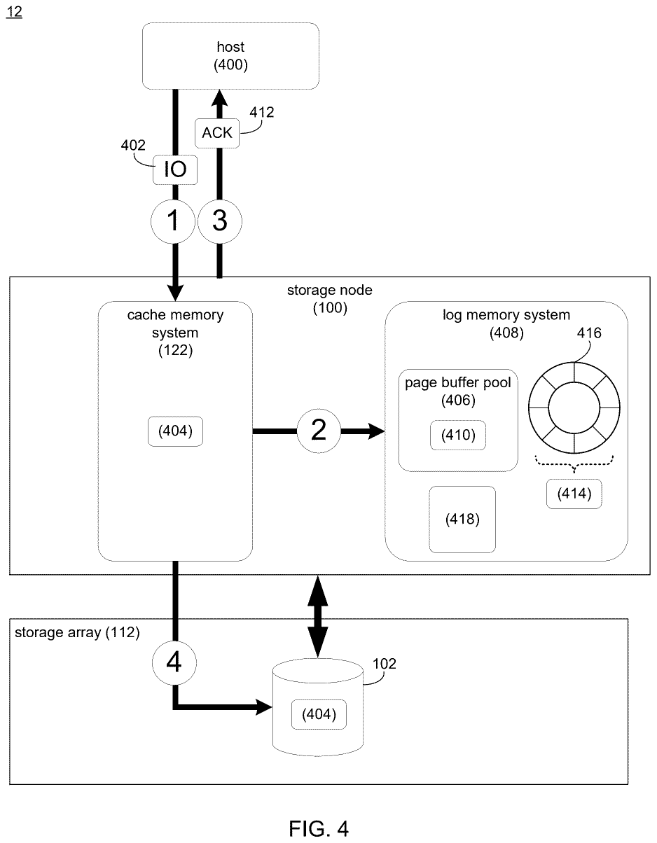

In some implementations, cache recovery process 10 may process 300 a plurality of user data pages on a cache memory system for writing to a storage system by generating a corresponding page descriptor for each user data page in a log memory system. For example and referring also to FIG. 4, suppose a host (e.g., host 400) sends an IO request (e.g., IO request 402) to write data to a storage array (e.g., storage array 112) using a storage node (e.g., storage node 100). In this example, cache recovery process 10 may write the data (e.g., page 404) to the cache memory system (e.g., cache memory system 122) of the processing storage node (e.g., storage node 100). This is shown as action “1” in FIG. 4. As will be discussed in greater detail below, it will be appreciated that a read IO operation may be processed on the storage node (e.g., storage node 100).

In some implementations, cache recovery process 10 may persist a plurality of pages in a plurality of page buffers within the page buffer pool based upon, at least in part, the processing of the plurality of IO operations. For example, cache recovery process 10 may write the data (e.g., page 404) to a page buffer pool (e.g., page buffer pool 406) of a log memory system (e.g., log memory system 408). The process of persisting 304 page 404 is shown as “2” in FIG. 4. As shown in FIG. 4, persistent page 404 may be represented as page buffer 410.

In some implementations, processing the plurality of user data pages on the log memory system may include generating a corresponding page descriptor associated with each user data page. A page descriptor may generally include a reference or pointer to a page buffer that includes a logical address of the data the corresponding page buffer contains. The page descriptor may also include a sequence transaction number that tracks the order of write operations. Additionally, the page descriptor may include other types of information. In some implementations, cache recovery process 10 may store each page descriptor in a data structure of the log memory system. For example, cache recovery process 10 may store each page descriptor in a page descriptor ring. As is known in the art, a ring buffer may allow data to be added to the “head” of the ring buffer and released or overwritten from the tail of the ring buffer. In this manner, the ring buffer may appear to be circular in that older data is overwritten with newer data. In some implementations, the page descriptor may be utilized to recover data during a restart or storage system failure. For example, page descriptors may be used to determine the order of page buffers to apply to recover a storage system. In some implementations, the corresponding page descriptor for each user data page of the plurality of user data pages include a plurality of corresponding page descriptors between a head and a tail of the log memory system. For example and as will be described in greater detail below, when restoring user data pages may include processing the page descriptors from the page descriptor ring during a recovery operation to determine whether the user data pages have been flushed from cache memory system 122.

In some implementations, data may be considered to be persisted when a page descriptor is generated. For example, once a page descriptor is stored in the log memory system, the content and order of a page buffer may be recovered during a storage system failure or restart. Referring again to FIG. 4, cache recovery process 10 may send an acknowledgment signal (e.g., ACK 412) to the host device (e.g., host device 400) once the data (e.g., page 404) is persisted in non-volatile memory (e.g., log memory system 408). Specifically, once the page descriptor (e.g., page descriptor 414) is stored in the page descriptor ring (e.g., page descriptor ring 416). This is shown as “3” in FIG. 4.

In some implementations, cache recovery process 10 may flush 302 at least a portion of the plurality of user data pages from the cache memory system. For example, at some point in time after writing the data to the cache memory system and log memory system, data may be “flushed” 302 or written from the cache memory system to the persistent memory of the storage array. Flushing a page buffer may include flushing a page descriptor-page buffer pair. For example, when the page descriptor-page buffer pair is flushed, the data of the page buffer may be written (from the cache memory system) to the persistent memory of the storage system while the page descriptor may be retained.

Referring again to FIG. 4 and at some point in time after writing the data (e.g., page 404) to cache memory system 122 and log memory system 408, page 404 may be “flushed” or written from cache memory system 122 to the persistent memory of the storage array (e.g., storage array 112). Page 404 may be invalidated in cache memory system 122 during the flushing. This is shown as “4” in FIG. 4. In response to invalidating the page from the cache memory system, cache recovery process 10 may free the page buffer (e.g., page buffer 410) back to the page buffer pool (e.g., page buffer pool 406). For example, freeing the page buffer may include releasing the page buffer for writing and storing new data associated with a new IO write operation. In some implementations and in response to freeing the page buffer, cache recovery process 10 may mark the page buffer (e.g., page buffer 410) as flushed. In this manner, the page may be marked as flushed for a read IO operation.

In some implementations, cache recovery process 10 may generate 304 a special page descriptor defining an array of pointers to the at least a portion of the plurality of user data pages flushed from the cache memory system. A special page descriptor (e.g., special page descriptor 418) is a data structure used to describe the flushed status of a set of page descriptors. In some implementations, special page descriptor 418 is an array of pointers to all flushed page descriptors in page buffer pool 406. In some implementations, cache recovery process 10 allocates a number of special page descriptors to track the user data pages that have been flushed successfully. The special page descriptors may be persisted in the end of the flush process.

In some implementations, cache recovery process 10 may generate 308 a global sequence number for the special page descriptor as a value greater than a global sequence number associated with any user data page. A global sequence number (GSN) may be generated and assigned to each special page descriptor. Similarly, a unique global sequence number may be assigned to each page descriptor (e.g., page descriptor 414). As will be discussed in greater detail below, cache recovery process 10 uses the global sequence number of the special page descriptor and the global sequence numbers of the page descriptors to determine whether each user data page has been flushed. For example, if the global sequence number of one page descriptor described by the special descriptor page is smaller than the global sequence number of the special descriptor page, it indicates the page descriptor has been invalidated and has not been reused yet.

In some implementations, cache recovery process 10 may process 306 the special page descriptor during a recovery operation associated with the log memory system. For example, by using the special descriptor page, a recovery operation can identify all unflushed dirty user data pages referenced by corresponding page descriptors between the head and tail entries. In some implementations, these dirty user data pages are fed by cache recovery process 10 to the cache memory system in the same order they were ingested, allowing the cache memory system to recover to the state at which the storage system stopped.

In some implementations, processing 306 the special page descriptor during the recovery operation may include restoring 310 unflushed user data pages using the special page descriptor. For example, suppose the storage system experiences a failure or restarts. In this example, a recovery operation may be initiated on the storage system in response to determining the storage system failure or restart. Cache recovery process 10 may detect a recovery operation associated with the storage system. For example, the storage system may automatically detect a recovery event in response to a storage system failure.

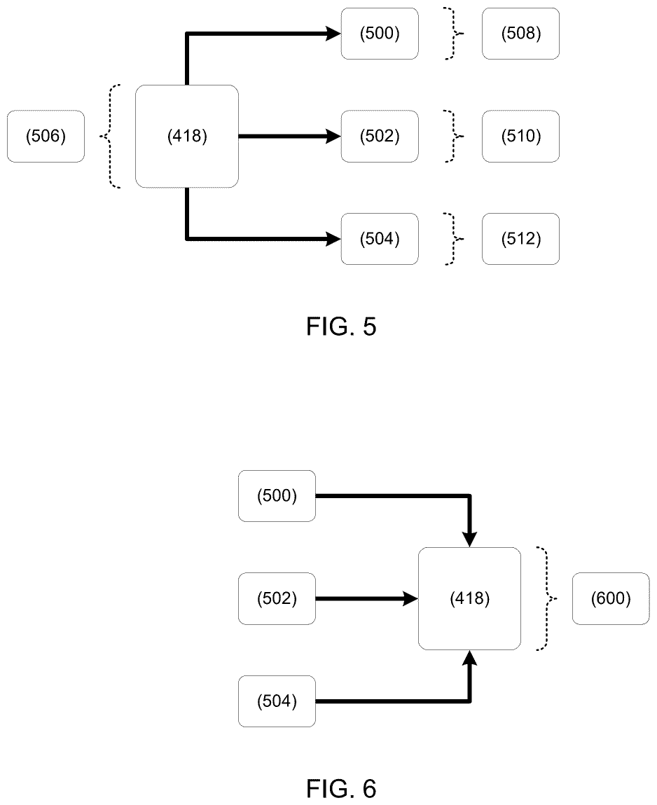

In some implementations, restoring 310 the unflushed user data pages may include comparing 312 the array of pointers of the special page descriptor to the plurality of user data pages. For example, by using a special page descriptor, the recovery operation can identify all unflushed dirty pages by identifying the plurality of user data pages with corresponding page descriptors subject to a pointer from the special page descriptor. For example and referring to FIG. 5, special page descriptor 418 includes an array of pointers to page descriptors 500, 502, 504 that are associated with distinct user data pages in cache memory system 122. Using special page descriptor 418, cache recovery process 10 identifies each page descriptor pointed to by special page descriptor 418 as flushed. Accordingly, cache recovery process 10 restores unflushed user data pages to cache memory system 122 by determining that user data pages associated with page descriptors 500, 502, 504 have been flushed, and therefore, do not need to be restored during the recovery operation.

In some implementations, cache recovery process 10 processes 312 the global sequence number for the special page descriptor by comparing the global sequence number to the global sequence number associated with each page descriptor. For example and as discussed above, each special page descriptor is assigned a global sequence number, which globally increases in a monotonous manner. Newly committed pages always have a larger global sequence number than those committed previously. If a page descriptor's global sequence number, as tracked by special page descriptor 418, is smaller than that of special page descriptor itself, it means the page descriptor has been invalidated and has not been reused yet. If the page descriptor's global sequence number is greater than that of special page descriptor, it means the page descriptor has been reused. For instance, and as shown in FIG. 5, special page descriptor 418 has global sequence number 506 of “100”; page descriptor 500 has global sequence number 508 of “40”; page descriptor 502 has global sequence number 510 of “10”; and page descriptor 504 has global sequence number 512 of “200”. In this example, because global sequence number 508 for page descriptor 500 and global sequence number 510 for page descriptor 502 is less than global sequence number 506 of special page descriptor 418, user data pages corresponding to page descriptors 500, 502 have been flushed and not reused, while page descriptor 504 has been reused. This approach addresses the challenge of differentiating between a free flushed page and a reused flushed page.

In some implementations, cache recovery process 10 may maintain 316 a reference count associated with remaining user data pages for each special page descriptor; and may reuse 318 the special page descriptor in response to determining that the reference count associated with the remaining user data pages is zero. For example and referring also to FIG. 6, special page descriptor 418 may be reused once all its associated page descriptors have been reused; otherwise, the flushed status of those page descriptors would be lost. To keep track, cache recovery process 10 maintains 316 a reference count of the remaining associated page descriptors. For example, page descriptors 500, 502, 504 that are pointed to by special page descriptor 418 may define a reference count of “3” page descriptors remaining/user data pages referenced by corresponding page descriptors. In some implementations, as page descriptors 500, 502, 504 are reused, cache recovery process 10 decrements the reference count until it reaches “0”. Accordingly in response to determining that the reference count associated with the remaining user data pages is zero, cache recovery process 10 reuses 318 special page descriptor 418 for a new set of page descriptors generated for user data pages in cache memory system 122.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. The language “one or more of A and B” (and the like) as well as “one or more of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
processing a plurality of user data pages on a cache memory system for writing to a storage system by generating a corresponding page descriptor for each user data page in a log memory system;
flushing at least a portion of the plurality of user data pages from the cache memory system;
generating a special page descriptor defining an array of pointers to the at least a portion of the plurality of user data pages flushed from the cache memory system; and
processing the special page descriptor during a recovery operation associated with the log memory system.

2. The computer-implemented method of claim 1, wherein processing the special page descriptor during the recovery operation includes restoring unflushed user data pages using the special page descriptor.

3. The computer-implemented method of claim 2, wherein restoring the unflushed user data pages includes comparing the array of pointers of the special page descriptor to the plurality of user data pages.

4. The computer-implemented method of claim 1, wherein the corresponding page descriptor for each user data page of the plurality of user data pages include a plurality of corresponding page descriptors between a head and a tail of the log memory system.

5. The computer-implemented method of claim 1, further comprising:
generating a global sequence number for the special page descriptor as a value greater than a global sequence number associated with any corresponding page descriptor.

6. The computer-implemented method of claim 5, further comprising:
processing the global sequence number for the special page descriptor by comparing the global sequence number to the global sequence number associated with each page descriptor.

7. The computer-implemented method of claim 1, further comprising:
maintaining a reference count associated with remaining user data pages for each special page descriptor; and
reusing the special page descriptor in response to determining that the reference count associated with the remaining user data pages is zero.

8. A computer program product residing on a non-transitory computer readable medium having a plurality of instructions stored thereon which, when executed by a processor, cause the processor to perform operations comprising:
processing a plurality of user data pages on a cache memory system for writing to a storage system by generating a corresponding page descriptor for each user data page in a log memory system;
flushing at least a portion of the plurality of user data pages from the cache memory system;
generating a special page descriptor defining an array of pointers to the at least a portion of the plurality of user data pages flushed from the cache memory system; and
processing the special page descriptor during a recovery operation associated with the log memory system.

9. The computer program product of claim 8, wherein processing the special page descriptor during the recovery operation includes restoring unflushed user data pages using the special page descriptor.

10. The computer program product of claim 9, wherein restoring the unflushed user data pages includes comparing the array of pointers of the special page descriptor to the plurality of user data pages.

11. The computer program product of claim 8, wherein the corresponding page descriptor for each user data page of the plurality of user data pages include a plurality of corresponding page descriptors between a head and a tail of the log memory system.

12. The computer program product of claim 8, wherein the operations further comprise:
generating a global sequence number for the special page descriptor as a value greater than a global sequence number associated with any corresponding page descriptor.

13. The computer program product of claim 12, wherein the operations further comprise:
processing the global sequence number for the special page descriptor by comparing the global sequence number to the global sequence number associated with each page descriptor.

14. The computer program product of claim 13, wherein the operations further comprise:
maintaining a reference count associated with remaining user data pages for each special page descriptor; and
reusing the special page descriptor in response to determining that the reference count associated with the remaining user data pages is zero.

15. A computing system comprising:
a memory; and
a processor configured to process a plurality of user data pages on a cache memory system for writing to a storage system by generating a corresponding page descriptor for each user data page in a log memory system, to flush at least a portion of the plurality of user data pages from the cache memory system, and to generate a special page descriptor defining an array of pointers to the at least a portion of the plurality of user data pages flushed from the cache memory system, and to process the special page descriptor during a recovery operation associated with the log memory system.

16. The computing system of claim 15, wherein processing the special page descriptor during the recovery operation includes restoring unflushed user data pages using the special page descriptor.

17. The computing system of claim 16, wherein restoring the unflushed user data pages includes comparing the array of pointers of the special page descriptor to the plurality of user data pages.

18. The computing system of claim 15, wherein the corresponding page descriptor for each user data page of the plurality of user data pages include a plurality of corresponding page descriptors between a head and a tail of the log memory system.

19. The computing system of claim 15, wherein the processor is further configured to:
generate a global sequence number for the special page descriptor as a value greater than a global sequence number associated with any corresponding page descriptor.

20. The computing system of claim 19, wherein the processor is further configured to:
process the global sequence number for the special page descriptor by comparing the global sequence number to the global sequence number associated with each page descriptor.
